(19) United States
(12) Patent Application Publication
(10) Pub. No.: US 2011/0017048 A1
(43) Pub. Date: Jan. 27, 2011

(54) DROP TUNE SYSTEM

(76) Inventor: Richard Bos, Saratoga Springs, UT (US)

Correspondence Address: HOLME ROBERTS & OWEN, LLP, 299 SOUTH MAIN, SUITE 1800, SALT LAKE CITY, UT, 84111, US

(21) Appl. No.: 12/507,717

(22) Filed: Jul. 22, 2009

(51) Int. Cl. G10H 1/00; G10G 7/02

(52) U.S. Cl. 84/600; 84/454

(57) ABSTRACT

A tuning device receives the electrical output of an instrument that reflects sound at a first tone level. The tuning device digitizes electrical output. The user has switches operable to generate control signals that are processed to effect a bypass of the device or to digitally drop the tone level in half steps up to an octave and to selectively mix the drop tone level with the input tone level. The user may then broadcast one of the bypassed signal, the drop tone signal or a mixed signal of the drop tone and the input tone level.

### BACKGROUND OF THE INVENTION

1. The Field of the Invention

This invention relates to systems to modify the electrical output of an musical instrument that generates an electrical output reflective of sound at a particular tone level and more particularly to devices that modify the electrical output so that it can be broadcast unmodified or modified, or combined in multiple formats.

2. The Relevant Technology

In order to create a musical effect, it is sometimes desirable to present the music as written at a lower or different pitch or tune. The process has been referred to as drop tuning. Drop tuning is typically associated with guitars. Drop tuning is discussed on several web sites on the world wide web such as at www.learnclassicalguitar.com. To drop tune one or more strings, those one or more strings are tuned down or dropped the equivalent of one or two or more frets. Drop tuning involves modifying the tuning of the guitar and thus is something that is not lightly undertaken because when the use at the lower or dropped tune level is complete, one must retune to the normal level. Alternately, one must have multiple guitars all tuned differently.

Electrical musical instruments like electrical guitars produce an electrical signal at a selected tone level. The electrical signal is typically amplified and sent to speakers which convert the electrical signal into sound. Users may wish to drop tune their electrical guitars or similar electrical musical instruments. However, the means to drop tune an electrical guitar are essentially the same as the non electrical instruments. Devices or systems to effect drop tuning easily without actually having to retune an electrical guitar are not known.

### BRIEF SUMMARY OF THE INVENTION

A device for modifying the electrical output of a musical instrument has an input configured to receive the electrical output of the musical instrument which is at a first pitch or tone level. A suitable electrical instrument includes, but is not limited to an electrical guitar or electrical bass guitar, acoustic guitars and even an electric bass fiddle. The device has change means to generate change signals for changing the first tone level to a second tone level. An analog to digital converter receives the analog electrical output at the first tone level and converts it to a first digital signal that is supplied to a digital signal processor. The digital signal processor is configured to change the first digital signal to a second digital signal that is the same as said first digital signal but modified to be at a second tone level that is different from the tone level of the first digital signal and to supply the second digital signal as the signal processor output.

The device has a controller that is connected to receive the change signals. The controller is configured to generate and supply control signals reflective of the desired change communicated by the change signals to create a second tone level different from the first tone level. The controller supplies signals to the digital signal processor to cause the digital signal processor to use the first digital signal to make or create the second digital signal as the signal processor output. The second digital signal is then supplied to a digital to analog converter to convert the signal processor output into an analog electrical output. The analog electrical output is then supplied to an output device which receives the analog electrical output and then supplies it as the device output for connection to a system for converting the analog electrical output into sound at the second tone level. The device also includes a power supply connected to its components to supply power thereto.

In a preferred arrangement, the change means is configured to generate a plurality of change signals to cause the electrical signals reflective of the sound at the first tone level to change to an electrical signal reflective of the sound at any one of a plurality of second tone levels. The change means may be a computer or other automatic device to generate the change signals in accordance with certain triggers which can be sounds or patterns of sound detected as music is being performed. Most preferably the change means is one or more manual switches positioned in a chassis or housing positioned for operating by the user. The housing or chassis is preferably of the type that can be positioned on the floor with switches being buttons operable by the feet of the user.

In a more preferred configuration, the device includes display means connected to the controller to receive the control signals and to the power supply to receive power there from. The display means is arranged to generate a visually perceivable image of the selected tone level from the plurality of tone levels available for the device output.

In a more preferred configuration, the device includes an output switch connected to receive the analog electrical output. The output switch is also connected to the device input to receive the electrical output of the musical instrument at the first tone level. The output switch is operable between a bypass position in which the electrical output of the musical instrument at the first tone level is supplied as the device output and a second position in which the analog electrical output is supplied as the device output.

Preferably the output switch is controlled by the controller which is connected to said output switch. The controller supplies control signals to cause the output switch to move between the bypass position and the second position. The change signals supplied to the controller preferably include a bypass signal. The controller, in turn, generates control signals that are sent to the output switch to cause the output switch to move between the bypass position and the second position.

In a more preferred configuration, the digital signal processor includes shift means for changing the first digital signal to any one of a plurality of second digital signals each being the first digital signal modified or shifted to be at any one of a plurality of tone levels each different from each other and from the first tone level. The controller supplies control signals to the digital signal processor. The control signals include a shift signal to cause the shift means to change the first digital signal to the second digital signal. Even more preferably, digital signal processor includes a mixer to cause said first digital and the second digital signal to be mixed and supplied as the signal processor output. The mixer being is operable between a non mix position in which the signal process output is the second digital signal and a mix position in which the signal processor output is the sum of the first digital signal and the second digital signal. Even more preferably, the first digital signal is mixed with a second digital signal that is an octave below the first digital signal. This is called an octaver.

In a more desired arrangement, the change means is configured to supply a mixing signal to the controller to cause the controller to supply a mix signal to the mixer in the digital signal processor to cause it to operate between the non mix position and the mix position.

In a preferred assembly, the display means includes an array of light emitting diodes each reflective of a tone level. The display means includes a driver to operate each of the light emitting diodes of the array in accordance with the control signals.

In a more preferred assembly, the device includes an input amplifier connected to receive the electrical output at said first tone level. It is configured to and to amplify the electrical output at said first tone level and to supply the amplified electrical output at said first tone level to the digital signal processor. Similarly, an output amplifier is connected to receive the analog electrical output and to supply the amplified analog electrical output to the output and more particularly to the output switch. Most preferably, the input amplifier and the output amplifier are each variable amplifiers operable by the user by any suitable means such as a knob.

The device in any of the above arrangements and configurations is part of a sound system that includes an instrument of the type that generates electrical signals reflective of sound at a first tone level upon operation by a player. Electrical guitars, electrical bass guitars, acoustic guitars, violins, and similar instruments are contemplated. The system includes a speaker system connected to the device to receive the device output and to broadcast sound reflective of one of the musical instruments' output at the first tone level and at said second tone level and at the mixture of the first tone level and the second tone level.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore, not to be considered limiting of its scope. The invention will be described and explained with additional specificity and detail through the use of the accompanying drawings in which:

FIG. 1 is a simplified block and line diagram of a drop tune device of the present invention;

FIG. 2 is a simplified block and line diagram of a drop tune system of the present invention;

FIG. 3 is a perspective view of a chassis of a drop tune device of the present invention;

FIG. 4 is a rear view of a chassis of a drop tune device of the present invention; and

FIG. 5 is a perspective of an alternate form of a chassis of a drop tune device of the present invention.

### DETAILED DESCRIPTION OF THE PREFERRED EMBODIMENTS

Music is typically written to be performed in a key that may range over several octaves depending on the particular music. The music being performed can be said to be performed at the sound level or tone level desired by the writer. On occasion, the performer may wish to play the music at a different level or tone level than as originally contemplated by the writer. As an example, one could play music an octave lower than as written by the writer of the music. For music to be performed by certain instruments like a guitar, the performer may wish to drop tune or change the sound level or tone of the music being performed for artistic reasons. Guitars and similar instruments may be specifically adapted or tuned to a different sound level or tone level that is typically below or at a lower tone level that the music as written. The practice of drop tuning instruments like a guitar has become accepted so that procedures for drop tuning are available from a number of sources. See, for example, HOW TO TUNE A GUITAR at www.howtotuneaguitar.org/tuning/drop-c on the world wide web.

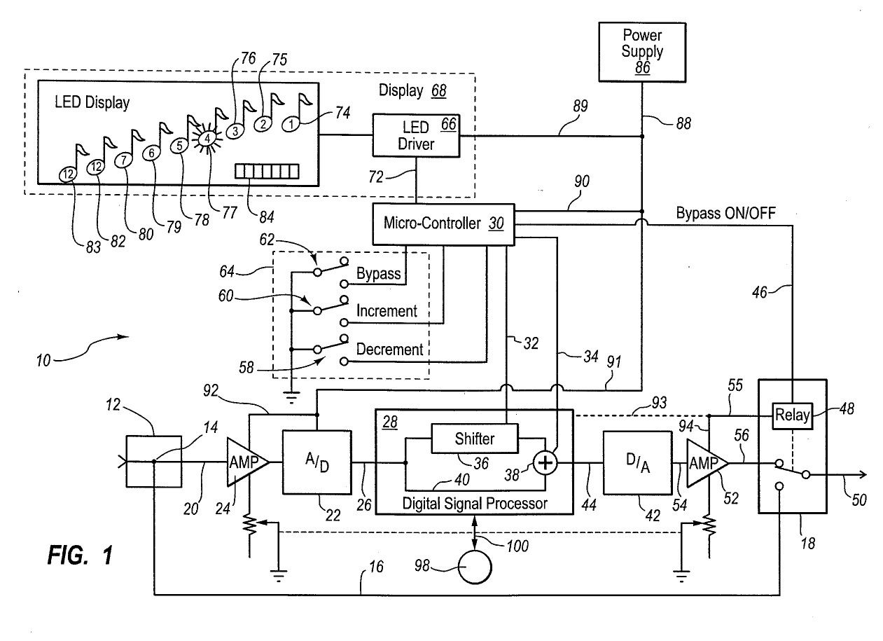

FIG. 1 is a line diagram of a device for selectively drop tuning the output of an electrical instrument like an electric guitar. That is, the instrument involved may be any one in a wide category of instruments that produce an electrical output for further amplification and broadcasting into audible sound over speakers. While electric guitars and bass guitars are specifically contemplated, other stringed electrical instruments including a string upright bass, and other various electric violins, violas, cellos, zithers, ukuleles, and the like, may susceptible to drop tuning.

The output of the electrical instrument is supplied to the input 12 of the device 10. The input 12 is a suitable receptacle sized to receive a connector at the end of a suitable wire or lead coming from the electrical instrument. The input 12 may be hard wired; but it is typically a female receptacle sized to receive a standard male connector. The input 12 may also be an array of receptacles to receive one male connector that may be one of several different sizes. The input 12 may also be configured with a fuse circuit (not shown) to protect the device 10 as well as appropriate line filters as may be desired to filter out undesired electronic signals that may be acquired (e.g., electromagnetic interference). The input 12 as shown has a node 14 to which a bypass conductor 16 is connected to transmit an incoming electrical output at a first tone level directly to the output 18 as more fully discussed hereinafter.

The input 12 is connected by conductor 20 to supply the incoming electrical output at a first tone level to an analog to digital converter 22 through an optional amplifier 24. The incoming electrical output is a first tone level that is an analog signal in that it may be viewed as a complex wave form that is varying in amplitude. The analog to digital converter 22 converts the incoming electrical output to a first digital signal for transmission via conductor 26 to a digital signal processor 28. An AK5358 ETP 24 bit converter available from AKM Semiconductor, Inc. of San Jose, Calif. is believed to be a suitable device for electrical guitars. Of course, other suitable analog to digital converts (A/D) should be available from other manufacturers.

The digital signal processor 28 receives control signals from a micro controller 30. The control signals supplied by the microcontroller 30 include a shift signal via conductor 32 and a mix signal via conductor 34. The digital signal processor 28 includes a shifter 36 that is configured to shift the first digital signal at the first tone to a second digital signal at a second tone level selected or determined by the shift signal supplied to shifter 36 from the microcontroller 30 over conductor 32. The second digital signal is the same as the first digital signal but at a tone level that is different. More specifically, the tone level can be lower than the tone level of the first digital signal. Indeed, the tone level can be lowered in acoustic ½ steps up to and including 7 half steps or 3½ tone levels plus one step that is an octave and another that is an octaver.

The mixer 38 in the digital signal processor 28 is a summing circuit that can combine the second digital signal as the output of the shifter 36 with the first digital signal received via conductor 40 to produce a signal processor output that is supplied to a digital to analog converter 42 via conductor 44. The mixer 38 is operable between a non mix position in which the second digital signal is supplied as the signal processor output and a mix position in which the signal processor output is the combination of the first digital signal at the first tone level and a the second digital signal at the second tone level. A TMS 32006745 from Texas Instruments is believed to be a suitable digital signal processor 28. Other possible digital signal processors are discussed at http://en.wikipeida.org/wiki/Digital_signal_processor.

The microcontroller 30 is a small computer that is specifically configured to generate digital control signals for the digital signal processor 28 and, more particularly, the mix signal that is sent via conductor 34 and the shift signal sent via conductor 32. Microcontrollers of the type used are discussed at http://en.wikipedia.org/wiki/Mircrocomputer. A C 8051F335GM made by Silicon Laboratories, Inc. of Austin, Tex. has been found to be a suitable microcontroller 30. The microcontroller 30 also supplies a digital control signal or bypass signal that is also supplied via conductor 46 to the output 18 to control a relay switch 48 which moves between a by pass position in which the electrical output at the firs tone level is received via conductor 16 and supplied as the device output via conductor 49 and connector 50 and a second or drop tune position in which the device output is received from the digital to analog converter (D/A) 42 via optional amplifier 52 via conductors 54 and 56. The connector 50 is a male receptacle sized to receive a standard female connector. It may also be an array of receptacles to receive a connector of a different size.

Change means 64 are provided to supply change signals to the microcontroller 30 to cause the microcontroller 30 to supply the control signals via conductors 32, 34 and 46. The change means 64 can be any structure configured to supply signals to cause change. Thus, a computer system or any other automatic or semiautomatic device may be configured to supply change signals in accordance with instructions provided to the computer. However, the change means 64 as shown and as presently preferred includes a decrement switch 58 which supplies an electrical signal to the microcomputer to cause it to generate a shift signal to, in turn, cause the shifter 36 to shift the first digital signal down or decrement the first digital signal to create the second digital signal. Of course, the second digital signal is then supplied to the mixer 38 which is connected to and supplies the signal processor output to the digital to analog converter 42 via conductor 44. Similarly, an increment switch 60 is connected to supply an electrical signal to the microcontroller 30 to generate a shift signal to cause the shifter 36 to shift the first digital signal up an increment upward. Thus, the shifter 36 may be at a level to cause the first digital signal to be lowered 2 and ½ steps. By operating the increment switch 60, the shifter 36 is configured (e.g., moved to a desired ½ step) to step the second digital signal toward or to the first digital signal. The decrement switch 58 can be operated (e.g., depressed) to cause the shifter 36 to decrement down up to 3½ steps or 7 half tones plus one octave and to an octaver position. The increment switch 60 can be operated to cause the shifter 36 to move up from the octaver position to the octave and through the 7 half step positions as desired by the user/operator. The increment switch 60 and the decrement switch 58 may preferably be spring loaded push button switches. Suitable switches are available from NKK switches on the world wide web at http://www.nkksswitches.com.

The change means 64 may also include a bypass switch 62 that is operable to supply the bypass signal via conductor 46 to the output 18 and in turn cause the relay switch 48 to move between the by pass position and the second or drop tune position.

Returning to the digital signal processor 28, the signal processor output is supplied to a digital to analog converter 44 such as 24 bit AK4388ETP offered by AKM. The second digital signal or the combination of the second digital signal and the first digital signal is supplied as the digital signal output of the digital signal processor 28 to an analog signal that is optionally amplified by an amplifier like a NJM 4580E that, in turn, is provided as the device output through the relay switch (such as a SC1C-5HS that is offered by World Products) when the relay is in the second or drop tune position shown in FIG. 1. The analog signal is of the type that drives or operates suitable speakers of a sound system to provide audible sound that the player or musician seeks to present to the listener.

In FIG. 1, the microcontroller 30 is shown supplying control signals via conductor 72 to display 68 that includes an LED driver 66 and an LED display 70. The LED driver 66 may by any suitable circuit configured to drive an array of light emitting diodes (LED). Various circuits may be used such as those offered by LINEAR Technology at www/linear.com/pc/view/Category on the world wide web. The LED display 70 includes visual or perceivable images 74-83 of the steps or levels that have been selected by operating the decrement and the increment switches 58 and 60 of the change means 64.

The LED Driver 66 also receives a signal from the mixer 38 via conductor 34 and microcontroller 30 reflective of the level of the acoustic signal being supplied as the signal processor output. The level or volume of the signal is then displayed in a multicolor level indicator 84.

The device 10 of FIG. 1. also has a source of power or a power supply 86 that is connected to supply power to the display 68 and the other components over conductors 88-95 as seen in FIG. 1. The power supply may be any source of electrical power including 115 V outlet power that is suitably reduced and isolated with fuses to provide the desired power for the desired circuits.

It may also be noted that the input amplifier 24 and the output amplifier 52 are each operable by suitable means to vary the amplification level. As shown, the amplifiers have a variable resistor that is operable by a dial, knob or slide 98 that are ganged together to move both up and down 100 so they are operated in tandem or together. Thus, the amplifiers 24 and 52 are operated at substantially equal levels.

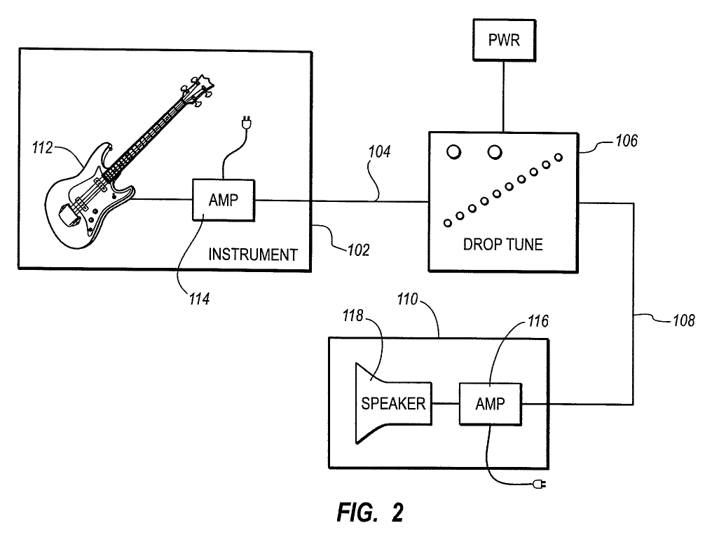

A system is shown in FIG. 2 that includes an instrument 102 that supplies an electrical output via conductor 104 to a drop tune device 106 comparable to drop tune device 10. The output of the drop tune device 106 is supplied via a suitable conductor 108 that is suitably connected to a speaker system 110 which converts the device output into sound energy that is audible. The instrument 102 shown is a guitar 112 that includes a standard output amplifier 114 that receives power from a conventional outlet. The speaker system 110 includes a suitable amplifier 116 and a speaker arrangement 118. Power may be supplied from any suitable source such as an outlet.

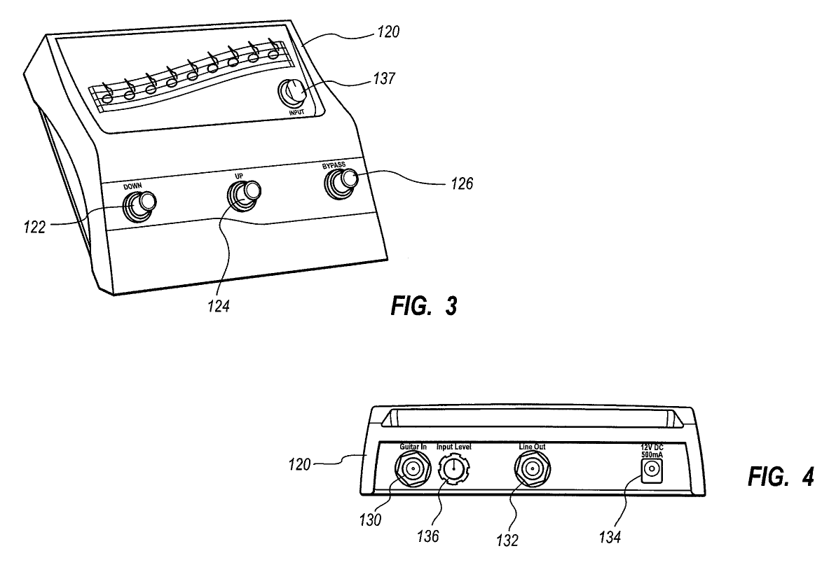

In FIGS. 3 and 4 shows a suitable chassis 120 that contains all the components of FIG. 1 with suitable push button switches 122, 124 and 126 that are comparable to the decrement switch 58, increment switch 60 and a bypass switch 62. The visually perceivable display 128 is comparable to visual LED display 68 and the array of LED's 74-83. The input connector receptacle 130 that connects to and is part of the input such as input 12 is also visible as is the output connector 132 that is comparable to output connector receptacle 50. Power may be supplied to the device 120 by a suitable transformer to the device via connector receptacle 134. The level of the input amplifier and the output amplifier may be controlled by the knob 136 that is comparable to the control 98 of FIG. 1.

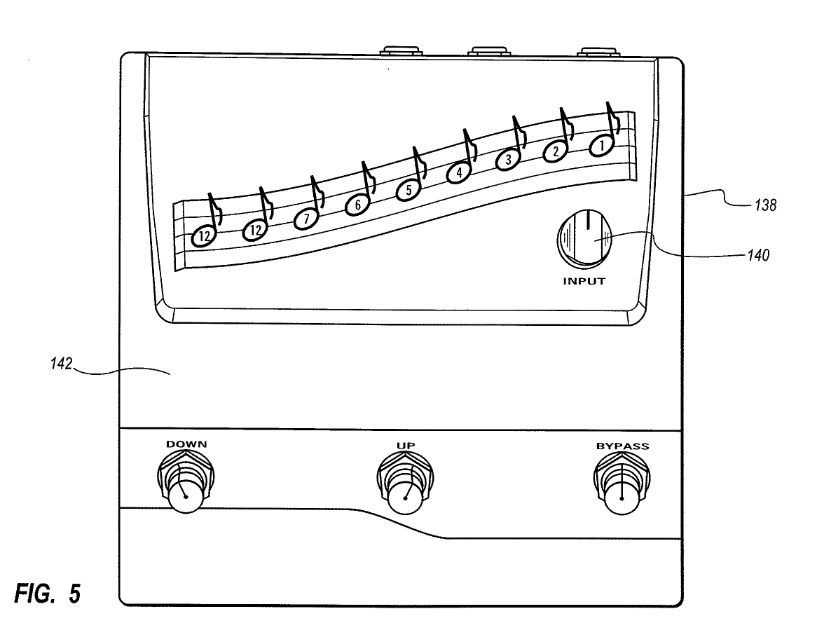

An alternate chassis 138 is shown in FIG. 5 that is comparable to the chassis 120 of FIG. 4 with the amplifier control knob 140 on the face or top 142 of the chassis 138 in lieu of the sound level indicator 84 seen in FIG. 1 and the sound level indicator 137 seen in FIG. 4.

In operation the device 10 of FIG. 1 and the system of FIG. 2 can be operated to drop tune an electrical instrument like a guitar in ½ tone steps up to 3 and ½ steps. Thus, an guitarist playing an E chord can use the device 10 to decrement to an E flat, D, D flat, C, B, B flat or A by pushing the decrement button. Once decremented down, the device can increment up through the same chords by operating the increment switch such as switch 60. The BYPASS switch like switch 62 can be depressed to switch the relay between the bypass position and the drop tune position at the level previously selected. The LED Display will show the drop tune level selected by illuminating the appropriate LED for that which has been selected. Notably, the user can continue to depress the decrement switch to select a full octave drop and also an octaver in the tuning.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A device for modifying the electrical output of a musical instrument of the type that generates an electrical output reflective of sound at a first tone level, said device comprising:
an input configured to receive the electrical output of said musical instrument at said first tone level;
change means to generate change signals for changing said electrical output reflective of sound at said first tone level to an electrical output reflective of said sound at a second tone level different from said first tone level;
an analog to digital converter connected to said input to receive said electrical output at said first tone level and configured to convert said electrical output at said first tone level to a first digital signal;
a controller connected to receive said change signals and configured to generate and supply control signals reflective of said change to said first tone level;
a digital signal processor connected to receive said first digital signal and said control signals, said digital signal processor being configured to change said first digital signal to a second digital signal that is the same as said first digital signal modified to be at said second tone level and to supply said second digital signal as the signal processor output;
a digital to analog converter connected to said digital signal processor to receive said signal processor output and configured to convert said signal processor output into an analog electrical output;
an output connected to said digital to analog converter to receive said analog electrical output, said output being configured for connection to a system for converting said analog electrical output to sound at said second tone level; and
power supply means connected to said controller, said analog to digital converter, said digital signal processor and said digital to analog converter to supply power thereto.

2. The device of claim 1, wherein said change means is configured to generate a plurality of change signals to cause said electrical signals reflective of the sound at said first tone level to change to an electrical signal reflective of said sound at any one of a plurality of second tone levels.

3. The device of claim 2, further including display means connected to said controller to receive said control signals there from and connected to said power supply to receive power there from, said display means being arranged to generate a visually perceivable image of the tone level of the plurality of second tone levels.

4. The device of claim 3, further wherein said out put includes an output switch connected to receive said analog electrical output, wherein said input is connected to said output switch to supply said electrical output of said musical instrument at said first tone level to said output switch, said output switch being operable between a bypass position in which said electrical output of said musical instrument at said first tone level is supplied as the device output and a second position in which said analog electrical output is supplied as the device output.

5. The device of claim 4, wherein said controller is connected to said output switch to supply control signals to cause said output switch to move between said bypass position and said second position, wherein said change signals include a bypass signal that is supplied to said controller which in turn generates said control signals to cause said output switch to move to said bypass position.

6. The device of claim 5, wherein said digital signal processor includes shift means for changing said first digital signal to any one of a plurality of second digital signals each being said first digital signal at any one of said plurality of different tone levels.

7. The device of claim 6, wherein said control signals supplied to said digital signal processor includes a shift signal to cause said shift means to change said first digital signal to any one of said plurality of different tone levels.

8. The device of claim 7, wherein said digital signal processor includes a mixer to cause said first digital and said second digital signal to be mixed and supplied as the signal processor output, said mixer being operable between a non mix position in which the signal process output is the second digital signal and a mix position in which the signal processor output is the sum of the first digital signal and the second digital signal.

9. The device of claim 8, wherein said change means is configured to supply a mixing signal to said controller to cause said controller to supply a mix signal to said mixer to cause it to operate between said non mix position and said mix position.

10. The device of claim 9, wherein said display means includes an array of light emitting diodes each reflective of a tone level of said plurality of different tone levels and wherein said display means includes a driver to operate each of said light emitting diodes of said array in accordance with said control signals.

11. The device of claim 10, further including an input amplifier connected to receive said electrical output at said first tone level and to amplify said electrical output at said first tone level and to amplify and supply said electrical output at said first tone level to said digital signal processor.

12. The device of claim 11, further including an output amplifier connected to receive said analog electrical output and to amplify and supply said analog electrical output to said output switch.

13. The device of claim 12, in which said input amplifier and said output amplifier are each variable amplifiers having means to vary the amplification operable by the user.

14. The device of claim 13, wherein said means to vary the amplification of the input amplifier and the means to vary the amplification of said output amplifier are both variable together by operation of one knob

15. The device of claim 14, wherein said change means includes a chassis for positioning on a support surface.

16. The device of claim 15, wherein said chassis includes a decrement switch operable by the user to cause said tone level of said signal processor output to change down.

17. The device of claim 16, wherein said chassis includes an increment switch operable by the user to cause said tone level of said signal processor output to change up.

18. The device of claim 17, wherein said chassis has a bypass switch operable by the user to cause said output switch to move to the bypass position.

19. The device of claim 18, wherein said chassis includes a switch to cause said first digital signal to combine with said second digital signal.

20. The device of claim 19, wherein said one of said increment switch and said decrement switch is operable to cause said mixer to move between said non mix position and said mix position, switch the device of claim chassis on the floor push buttons.

21. The device of claim 20, wherein said chassis is configured for placement on a floor surface and wherein said increment switch, said decrement switch and said bypass switch are all two position.

22. The device of claim 21, wherein said plurality of tone levels is 3½ tone levels in one half tone steps from the first tone level.

23. The device of claim 22, wherein said plurality of tone levels includes a second tone level one octave below the first tone level.

24. A device for modifying the electrical output of a musical instrument of the type that generates an electrical output reflective of sound at a first tone level, said device comprising:
an input configured to receive the electrical output of said musical instrument at said first tone level;
change means to generate change signals including signals for changing said sound at said first tone level to said sound at second tone levels each different from said first tone level, for generating a mix signal to cause signals reflective of sound at said first tone level to be mixed with signals reflective of sound at said second tone level, and for bypassing to cause the sound at said first tone level to be the device output;
an analog to digital converter connected to said input to receive said electrical output at said first tone level and configured to convert said electrical output at said first tone level to a first digital signal;
a controller connected to receive said change signals and configured to generate and supply a tone change signal and mix signals reflective of said change signals;
a digital signal processor connected having a mixer and having means to shift signals connected to receive said first digital signal and said tone change signals, said means to shift being configured to change said first digital signal to a second digital signal that is the same as said first digital signal modified to be at one of said second tone levels, said mixer being connected to receive said first digital signals and said second digital signals, and said mixer being connected to receive said mixer signals and configured to be operable between a non mix position in which the second digital signal is supplied as the signal processor output and a mix position in which said first digital signal and said second digital signal are mixed together and are supplied as the signal processor output;
a digital to analog converter connected to said digital signal processor to receive said signal processor output and configured to convert said signal processor output into an analog electrical output,
an output connected to said digital to analog converter to receive said analog electrical output there from and to said input to receive there from said electrical output of said musical instrument, said switch being connected to receive said analog electrical output and said electrical output of said musical instrument at said first tone level, said output switch being operable between a bypass position in which said electrical output of said musical instrument at said first tone level is supplied as the device output and a drop tune position in which aid analog electrical output is supplied as the device output, and said output being connected to said controller to receive said bypass signal to cause said output switch to move between said bypass position and said first position;
display means connected to said controller to receive said control signals there from and said display means being arranged to generate a visually perceivable image of each of said plurality of tone levels; and
power supply means connected to said controller, said analog to digital converter, said digital signal processor, said display means and said digital to analog converter to supply power thereto; and

25. A sound system comprising:
an instrument of the type that generates electrical signals reflective of sound at a first tone level upon operation by a player;
device comprising:
an input configured to receive the electrical output of said musical instrument at said first tone level,
change means to generate change signals including signals for changing said sound at said first tone level to said sound at second tone levels each different from said first tone level, for generating a mix signal to cause signals reflective of sound at said first tone level to be mixed with signals reflective of sound at said second tone level, and for bypassing to cause the sound at said first tone level to be the device output,
an analog to digital converter connected to said input to receive said electrical output at said first tone level and configured to convert said electrical output at said first tone level to a first digital signal,
a controller connected to receive said change signals and configured to generate and supply a tone change signal and mix signals reflective of said change signals,
a digital signal processor connected having a mixer and having means to shift signals connected to receive said first digital signal and said tone change signals, said means to shift being configured to change said first digital signal to a second digital signal that is the same as said first digital signal modified to be at one of said second tone levels, said mixer being connected to receive said first digital signals and said second digital signals, and said mixer being connected to receive said mixer signals and configured to be operable between a non mix position in which the second digital signal is supplied as the signal processor output and a mix position in which said first digital signal and said second digital signal are mixed together and are supplied as the signal processor output, a digital to analog converter connected to said digital signal processor to receive said signal processor output and configured to convert said signal processor output into an analog electrical output;
an output connected to said digital to analog converter to receive said analog electrical output there from and to said input to receive there from said electrical output of said musical instrument, said output having a switch connected to receive said analog electrical output and said electrical output of said musical instrument at said first tone level, said switch being operable between a bypass position in which said electrical output of said musical instrument at said first tone level is supplied as the device output and a drop tune position in which said analog electrical output is supplied as the device output, and said output being connected to said controller to receive said bypass signal to cause said output switch to move between said bypass position and said drop tune position,
display means connected to said controller to receive said control signals there from and said display means being arranged to generate a visually perceivable image of each of said plurality of tone levels, and
power supply means connected to said controller, said analog to digital converter, said digital signal processor, said display means and said digital to analog converter to supply power thereto; and
a speaker system connected to said device to receive said device output and to broadcast sound reflective of one of said musical instrument out put at said first tone level and at said second tone level and at the mixture of said first tone level and said second tone level.
